(19) United States
(12) Patent Application Publication
(10) Pub. No.: US 2024/0428329 A1
(43) Pub. Date: Dec. 26, 2024

(54) SYSTEM AND METHOD FOR EFFICIENT SHARING AND REPLICATION OF TRADING ANALYSIS

(71) Applicant: Agfin SIA, Ventspils (LV)

(72) Inventor: Janis Drobisevskis, Latvia (LV)

(21) Appl. No.: 18/372,131

(22) Filed: Sep. 25, 2023

Related U.S. Application Data
(60) Provisional application No. 63/522,728, filed on Jun. 23, 2023.

(51) Int. Cl. G06Q 40/04; G06F 3/04845; G06F 40/169

(52) U.S. Cl. CPC G06Q 40/04; G06F 3/04845; G06F 40/169

(57) ABSTRACT

A system for efficient sharing and replication of trading analysis, the system comprising: hardware processors; and a memory coupled to the hardware processors, wherein the memory comprises: a input module configured to enable a first user to create personalized chart analysis and annotations on a financial chart interface, and to draw lines, circles, add text comments, and integrate indicators on the financial chart interface using intuitive tools; a market analysis module configured to enable the first user to share the personalized chart analysis and annotations with a second user through various modes, the market analysis module configured to facilitate access to the chart analysis and annotations through a simple click on a financial chart interface of the second user; and a output module configured to capture and replicate the personalized chart analysis and annotations of the first user on the financial chart interface of the second user.

### CROSS REFERENCE TO RELATED APPLICATION

The present application is a non-provisional of, and claims benefit of priority from, U.S. Provisional Patent Application No. 63/522,728, entitled “A System and Method For Comprehensive Trading Analysis,” filed Jun. 23, 2023, the entirety of which is expressly incorporated by reference.

### FIELD OF INVENTION

Embodiments of a present disclosure relate to the field of trading analysis and more particularly to a system and method for seamless transfer and replication of trading analysis for example, personalized chart analysis, drawings, and annotations from one user to another.

### BACKGROUND

The following cited patents and publications are relevant to trading analysis aspects of the present invention, and are herein expressly incorporated by reference:

U.S. Pat. No. 7,991,672 incorporated herein by reference, discloses a system and method for calculating and arraying an entirely universe of publicly traded stock performance data, technical and dynamic range of movement stock price data, underlying operating corporate balance sheet plus income statement fundamental data and ratios, and derived corporate operating and stock analysis data in such a manner as to enable the data for any selected single company to be phased, combined and superimposed within a series of graphical illustrations, which enable investors to easily visualize and compare the relationship of stock price movement and the underlying progression of fundamental operating variables of companies listed on exchanges around the world. It is clear that the system of the present invention is useful adjuncts to the system disclosed in U.S. Pat. No. 7,991,672.

U.S. Pat. No. 10,497,060 incorporated herein by reference, discloses a system for intelligent market trading implemented with a neural network system (Machine Learning) comprising an input, processors and an output. The input comprises a database of price of a symbol and a pair in a timeframe. It is also clear that the system of the present invention is useful adjuncts to the system disclosed in U.S. Pat. No. 10,497,060.

U.S. patent application Ser. No. 12/000,241 incorporated herein by reference, discloses an approach for providing segmented market forecasts. A query is received from a user via a graphical user interface. Market analysis information is retrieved from a data repository in response to the query, wherein the market analysis information includes forecast data about a product and associated components in relation to a plurality of market segments, the data being hierarchically arranged with respect to the components.

U.S. patent application Ser. No. 17/486,368 incorporated herein by reference, discloses a computer-implemented method includes retrieving structures pertaining to a current state of a financial portfolio of a first user, historical and/or current states of a financial market, predictions regarding financial assets of the financial market, and the first user's preferences with respect to the financial portfolio.

The above-mentioned references are exemplary, and are not meant to be limiting in respect to the resources and/or technologies available to those skilled in the art.

The advent of online trading platforms has revolutionized the financial markets, granting individuals unprecedented access to global markets and investment opportunities. However, the success of trading endeavors is contingent upon accurate analysis, effective strategy evaluation, and timely decision making. Further the conventional trading simulation and real-time systems have limited functionality, primarily focusing on basic trading simulations rather than comprehensive analysis and strategy evaluation.

More specifically, the conventional trading systems and platforms often fall short in providing comprehensive functionality, lacking the depth necessary for achieving consistent profitability. Moreover, traders using the conventional systems are frequently left with fragmented tools and inadequate resources, impeding their ability to make informed decisions.

Further, the traders using conventional systems encounter fragmented tools and limited resources, hindering their capacity for informed decision making. Due to the inefficiencies of these systems, traders and learners struggle to accurately analyze market trends, identify patterns, and evaluate strategy performance with precision. As a result, decision-making processes may be impaired, leading to suboptimal trading outcomes and missed opportunities.

Additionally, the conventional trading platforms serves as a software application or an online platform that facilitates trading activities in financial markets and provides traders with access to market data, trading tools, charting capabilities, order execution functionality, and other features necessary for conducting trades. While the conventional trading platforms typically offer a range of functionalities to enhance the trading experience, there are instances where certain data, such as indicators, cannot be easily copied from one chart to another.

In addition to this, when the user wants to apply the same set of indicators or analysis techniques to multiple charts, the user needs to manually replicate the configuration on each chart individually, which requires extra time and effort, particularly the user need to perform the replication task frequently or across numerous charts, which makes this manual replication task tedious and inefficient, taking away valuable time that could be spent on other trading activities.

Moreover, the manual replication of indicators from one chart to another increases the likelihood of errors. The user unintentionally input incorrect settings or parameters, leading to inconsistent or inaccurate analysis across different charts and the errors adversely affect trading decisions and potentially lead to financial losses if not identified and rectified promptly.

Further, the inability to copy indicators from one chart to another disrupts the workflow and efficiency of the user. The user needs to switch back and forth between charts, manually inputting indicator settings each time, which can be time-consuming and disrupt the concentration and the fragmented workflow may lead to distractions and reduced focus, impacting overall trading performance.

Furthermore, conventional systems and methods for trading simulation fail to provide realistic market simulations, engaging educational experiences, and a diverse range of financial instruments. The lack of realism hampers user learning and decision-making processes, resulting in limited knowledge and progress. The engaging environments are crucial for users to develop effective trading skills, but conventional systems often lack the necessary features. Moreover, limited access to a wide range of financial instruments restricts users' exposure to different asset classes and their understanding of diverse trading scenarios. Additionally, the traders or learners are deprived of valuable insights into trading strategies, impeding their ability to learn from experienced traders, comprehend market dynamics, and refine their own trading approaches.

Additionally, the conventional systems and methods often fail to provide users with valuable insights into trading strategies. The absence of such guidance makes challenging for the traders and learners to grasp the underlying principles and techniques employed by successful traders. As the access to insights into trading strategies is vital for users to learn, understand market dynamics, and refine the own trading approaches, drawing from the experiences of seasoned traders.

Hence, there is a need for Hence, there is a need for system and method for seamless transfer of trading analysis for example, personalized chart analysis, drawings, and annotations from one user to another.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a system for efficient sharing and replication of trading analysis is disclosed. The system includes of at least one hardware processor and a memory coupled to the at least one hardware processor. The memory comprises a plurality of modules in the form of programmable instructions executable by the at least one hardware processor. The plurality of modules comprises of an input module, a market analysis module, and an output module. The input module is configured to receive a set of input details and contact details from a user, the input module configured to enable the first user to create personalized chart analysis and annotations on a financial chart interface by using a plurality of intuitive tools, wherein the plurality of intuitive tools configured to allow the first user to draw lines, circles, add text comments, and integrate indicators on the financial chart interface. The set of input details includes name, email address, password, phone number, date of birth, profile picture, personal preferences related to trading. The set of contact details include at least one email address or contact number of the user. The set of input details and contact details are used to create a user account and personalize an experience of the user within the system. The market analysis module is configured to enable the first user to share the personalized chart analysis and annotations with a second user through various modes, the market analysis module configured to facilitate access to the chart analysis and annotations through a simple click on a financial chart interface of the second user. The market analysis module is preferably accessed by a market analyst and the market analyst refers to an individual or entity responsible for analyzing market conditions, trends, and factors that impact a particular industry, product, or market segment. The market analyst provides at least one trading insight related to trading and market for analyzing the market conditions, trends, and factors that impact a particular industry, product, or market segment on the basis of set of input details provided by the user into the market analysis module and the at least one insight is also transmitted to the email address and/or contact number of the user. Further, the at least one trading insight includes drawing explanation, lines, circle, comments, arrows and other similar graphical representations that aid in illustrating and communicating market or trading insights. The user is allowed to copy the at least one trading insight to a dashboard that is displayed onto the output module. The dashboard serves as a consolidated view for the user, enabling them to access and review the market analysis data conveniently. The output module is configured to capture and replicate the personalized chart analysis and annotations of the first user on the financial chart interface of the second user, the market analysis module is configured to substitute the second user's chart interface with content, drawings, annotations, and activated indicators extracted from the financial chart interface of the first user.

In accordance with another embodiment of the present disclosure, a system for efficient sharing and replication of trading analysis is disclosed. The system includes a content creation module that registers the user as analysts by which the user is able to create a trade related content and share the trade related content along with the at least one trading insight which include drawings, analysis, and strategies for fostering a collaboration and a knowledge exchange among a user community.

In accordance with another embodiment of the present disclosure, a method for efficient sharing and replication of trading analysis is disclosed. The method comprising enabling a first user to create personalized chart analysis and annotations on a financial chart interface by using a plurality of intuitive tools and then finalizing analysis and annotations. Further the method comprising step of initiating the sharing process by the first user, who clicks on a designated button or link within the system to convey the completed analysis and annotations to a second user and further the method comprising in step of facilitating access to the shared content through a simple click on the chart interface of the second user. Further the method comprising step of substituting the second user's financial chart interface with the content, drawings, annotations, and activated indicators extracted from the original chart of the first user. Further the method comprising step of capturing and replicating the analytical perspective and thought process of the first user on the chart interface of the second user. Further the method comprising accessing, by a market analyst, a market analysis module, the market analyst being an individual or entity responsible for analysing market conditions, trends, and factors impacting a specific industry, product, or market segment. Further the method comprise of step of providing, by the market analyst, at least one trading insight related to trading and the market for analysing market conditions, trends, and factors impacting a particular industry, product, or market segment into the market analysis module, the at least one trading insight comprising drawing explanations, lines, circles, comments, arrows, and similar graphical elements.

In accordance with another embodiment of the present disclosure, a method for efficient sharing and replication of trading analysis is disclosed. The method initiates from selection of an asset and at least one chart is opened and the user including influencer, expert, analyst makes at least one trading insight such as annotations which include lines with comments on the at least one chart. The user is allowed to share the at least one trading insight with others. The at least one trading insight is copied including at least one setting like time frame, extra indicators and alike. The at least one option to share is provided and the options include email sharing, link sharing, embedding in an online social platform through articles, post or blogs.

In accordance with another embodiment of the present disclosure, a method for efficient sharing and replication of trading analysis is disclosed. The method initiates from adding at least one trading insight made by the user to the at least one chart in which the user is allowed to copy to chart, open in chart, and view in the chart. Further, a medium of transfer is selected which include options like article, blog post, tweet, SMS message or alike. The user identification is done by matching a unique identification data stored in a database. In addition to this, the status of the user identification is assigned or redirected into a first-time user, an existing user and a registered user. Further if the status of the user identification is first time user, then a cookie identification data is assigned or a mobile unique identification data is assigned. Further, the at least one trading insight is presented with the at least one annotation. In addition to this, if the status of the user identification is existing user, then the verification of the user is done by checking if the user has the mobile application and if the user does not have the mobile application, then a last used cookie identification data is extracted. The method includes checking of already store trading insights made by the user, further, if there are no already stored trading insights made by the user, then the current trading insights are presented to the chart. If there are already store trading insights made by the user, then, the already store trading insights are merged with current trading insights and presented to the chart. Whereas the already stored trading insights are cleared and added as new and further presented to the chart. In addition to this, the chart is opened in the mobile application and, the already stored trading insights are checked which are made by the user, if there is no already stored trading insights, then, the trading insights are pasted to the chart. Whereas, if the already stored trading insights are present, the already stored trading insight are merged with the already stored trading insights and pasted to the chart. Further, the already stored trading insights are cleared and added as new and pasted to the chart.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating an exemplary a system for efficient sharing and replication of trading analysis in accordance with an embodiment of the present disclosure;

FIG. 2 is another block diagram illustrating a system for efficient sharing and replication of trading analysis in accordance with an embodiment of the present disclosure;

FIG. 3 is a pictorial diagram illustrating an exemplary a system and method for efficient sharing and replication of trading analysis in accordance with an embodiment of the present disclosure;

FIG. 4 is a flow diagram illustrating an exemplary method for efficient sharing and replication of trading analysis in accordance with an embodiment of the present disclosure.

Further, those skilled in the art will appreciate that elements in the figures are illustrated for simplicity and may not have necessarily been drawn to scale. Furthermore, in terms of the construction of the device, at least one component of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that at least one device or sub-system or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

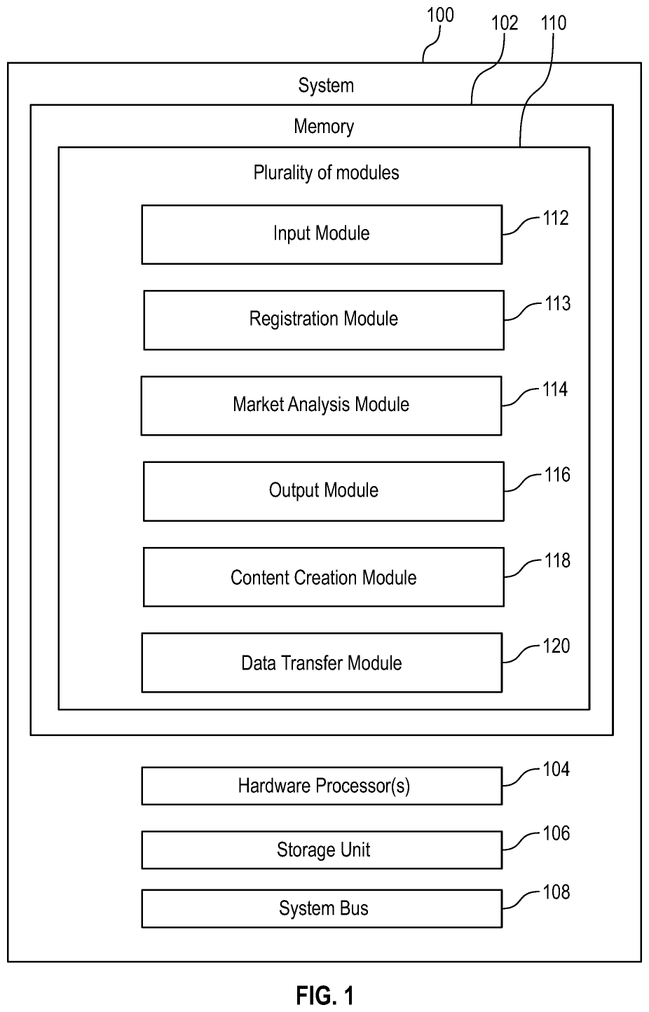

Referring now to the drawings, and more particularly to FIG. 1 through FIG. 4, where similar reference characters denote corresponding features consistently throughout the figures, there are shown preferred embodiments and these embodiments are described in the context of the following exemplary system and/or method.

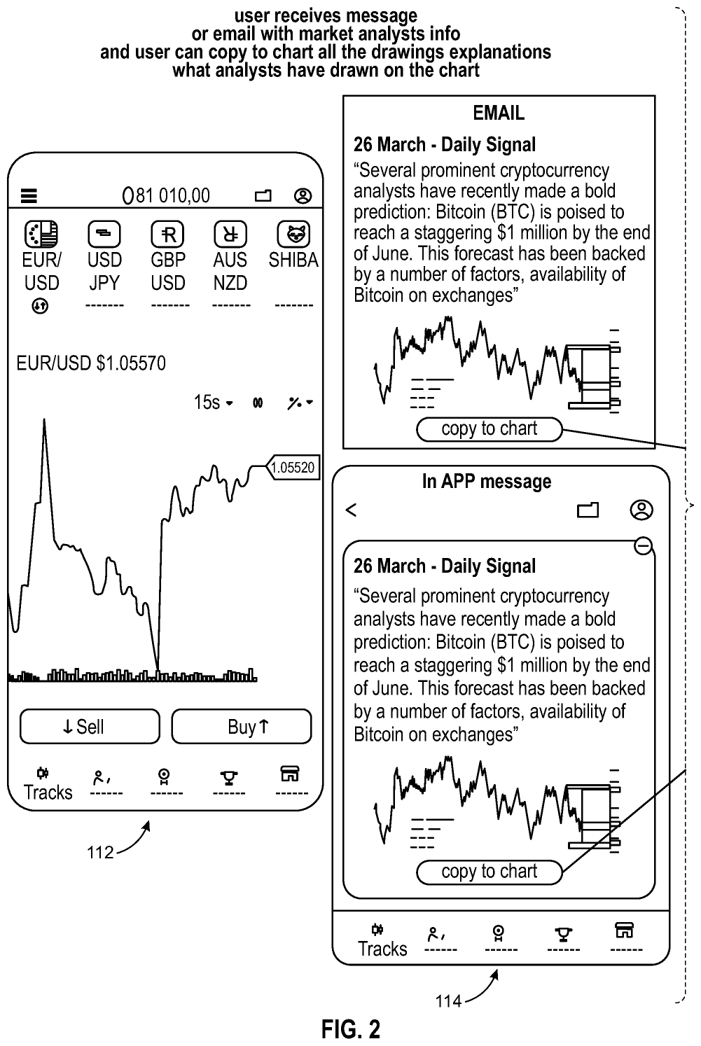

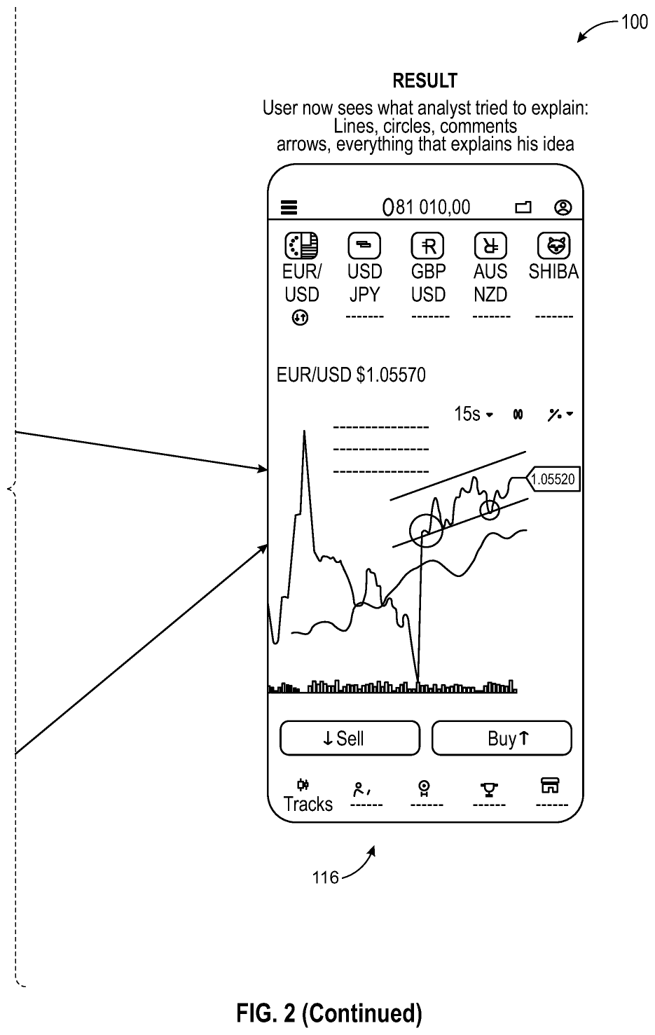

FIG. 1 and FIG. 2 are block diagrams illustrating a system for efficient sharing and replication of comprehensive trading analysis is disclosed, in accordance with embodiment of the present invention. According to FIG. 1 and FIG. 2, the system 100 for efficient sharing and replication of comprehensive trading analysis includes a memory 102, a hardware processor 104, a storage unit 106, a system bus 108 and a plurality of modules 110. The memory 102 comprises a plurality of modules 110 in the form of programmable instructions executable by the hardware processors. The memory 102, the hardware processors 104, the storage unit 106 are communicatively coupled through the system bus 108 or any similar mechanism. In an embodiment of the present disclosure, memory 102 is coupled to hardware processors 104. Memory 102 includes the plurality of modules 110 in the form of programmable instructions executable by hardware processors 104. In an embodiment of the present disclosure the plurality of modules 110 includes a chart input module 112, a market analysis module 114, and a chart output module 116. Details on the plurality of modules 110 have been elaborated in subsequent paragraphs of the present description.

The memory 102 may be non-transitory volatile memory and non-volatile memory. The memory 102 may be coupled for communication with the hardware processors 104, such as being a computer-readable storage medium. The hardware processors 104 may execute machine-readable instructions and/or source code stored in the memory 102. A variety of machine-readable instructions may be stored in and accessed from the memory 102. The memory 102 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 102 includes the plurality of modules 110 stored in the form of machine-readable instructions on any of the above-mentioned storage media and may be in communication with and executed by the hardware processors 104.

The hardware processors 104, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The hardware processors 104 may also include embedded controllers, such as generic or programmable logic devices or arrays, application specific integrated circuits, single-chip computers, and the like. The storage unit 106 may be a cloud storage or a local file directory within a remote server. In an embodiment of the present disclosure, the user receives message or email with market analysts' information and user may copy to chart all the drawings explanations, what analysts have drawn on the chart. User now sees what analyst tried to explain: Lines, circles, comments, arrows, everything that explains his idea. The email includes 26 March-Daily Signal “Several prominent cryptocurrency analysts have recently made a bold prediction: Bitcoin (BTC) is poised to reach a staggering $1 million by the end of June. This forecast has been backed by a number of factors, availability of Bitcoin on exchanges” shown in FIG. 2. In an embodiment of the present disclosure, the message includes 26 March-Daily Signal copy to chart “Several prominent cryptocurrency analysts have recently made a bold prediction: Bitcoin (BTC) is poised to reach a staggering $1 million by the end of June. This forecast has been backed by a number of factors, availability of Bitcoin on exchanges” shown in FIG. 2. The system 100 includes a sell option, a buy option, a copy to chart option, and the like. When the user has conducted thorough trading analysis and want to share insights with others, the system 100 allows the user to create and list analysis as a “Sell Option”. The user may set a price for analysis, making it available to other traders who are interested in purchasing insights. If the user looking for valuable trading insights and analysis, the system 100 provides a marketplace of buy option. Purchase the analysis that best aligns with the trading strategy and goals. Once the user purchased a trading analysis, the system 100 offers a copy to chart option. This copy to chart option allows the user to instantly apply the recommended trading parameters to the trading platform. The system 100 saves time and eliminate the potential for errors in manual replication.

The storage unit 106 may be a cloud storage or a local file directory within a remote server. The storage unit 106 may store the n details, the policy parameters and the merchandise information.

The input module 112 includes a financial chart interface that is accessible to traders, marked analysts, and users alike. This financial chart interface serves as the starting point for creating personalized chart analysis and annotations. The input module 112 is configured to receive a set of input details and contact details from a first user, the input module configured 112 to enable the first user to create personalized chart analysis and annotations on a financial chart interface by using a plurality of intuitive tools. The plurality of intuitive tools is configured to allow the first user to draw lines, circles, add text comments, and integrate indicators on the financial chart interface. The first user can visually depict their market insights directly on this chart interface. Additionally, the capability to enable various indicators, such as the moving average indicator, further enhances the depth of analysis. The seamless sharing of the annotations, analysis, and indicator settings from a first user's chart to a second user's chart. When a user, a trader, or a market analyst the first user (for example, a trader, or a market analyst) completes their annotations and analysis on the input module 112, they have the option to share their insights. This sharing process involves a one-click operation that generates a unique link or embeddable content. Upon receiving the link or embeddable content and activating it, the second user or recipient accesses the output module 116. Unlike the input module 112, this output module 116 already showcases the annotations, drawings, text comments, and indicator settings made by the first user. It serves as a window into the first user's perspective and analysis. This transformative sharing mechanism not only replicates the visual content but also ensures that the second user's chart reflects the exact same analysis environment as the first user's. The first user, the second user may include, but not limited, beginner, creator, analyst, trader, fellow users, hypothetical individuals like “Joe Baiden, recipient, expert trader, market analyst, and the like.

The system 100 ensures that this replication process encompasses every element of the analysis, including not only drawings, but also enabled indicators. When the second user interacts with the link or embeddable content, they effectively mirror the first user's chart, thus granting them an immediate understanding of the analysis at hand. This mechanism is not only secure but also guarantees the accuracy and consistency of the replicated analysis, rendering it valuable for traders of all levels. For example, the system 100 caters specifically to new traders or beginners eager to learn the ropes of the trading world. Designed with the beginner trader in mind, this system 100 introduce an uncomplicated approach to sharing and replicating chart analysis and annotations within financial trading platforms. The objective of the system 100 is to establish a supportive and collaborative learning environment, allowing the beginners to access expert insights and analysis with in an unmatched manner. For example, when a beginner completes their annotations and analysis within the input module 112, they are granted a seamless sharing option. A simple click generates a unique link or embeddable content, which can be effortlessly accessed by others. Upon activation, this content transforms the recipient's output module 116 into a learning portal, richly adorned with the original annotations, drawings, text comments, and indicator settings. This transfer doesn't just replicate the visual content, but also reproduces the educational journey and insights of the creator, empowering beginners to learn directly from experienced analysts. The system 100 can prevent unauthorized tampering, thereby preserving the sanctity of each individual's perspective.

The system 100, as described herein, encompasses various input devices such as a keyboard, mouse, electronic tablet, phone, and phone application which enable the user to interact with the system and provide the required input details. Specifically, the system 100 includes interfaces that facilitate the collection of the set of input details from the user. The interfaces serve as the means through which users input the set of input details using the mentioned input devices. For instance, users utilize a keyboard or electronic tablet to manually type in their name, email address, password, phone number, date of birth, and personal preferences related to trading. The set of input details and contact details are used to create a user account and personalize an experience of the user within the system.

Additionally, the system 100 may include interfaces designed for specific input devices such as phone applications. In this case, users leverage the functionalities provided by the phone application to enter the set of input details i.e. details conveniently. The interfaces are tailored to suit the respective input devices, ensuring a seamless and user-friendly experience.

The system 100, encompassing various input devices and interfaces, allows users to provide the necessary input details through the preferred means of interaction, by using a keyboard, mouse, electronic tablet, phone, or a dedicated phone application, the users utilize the input module to enter their information accurately and efficiently.

The market analysis module 114 is a digital tool designed to facilitate the sharing of market analysis content between different users. This module 114 serves as an example of how drawings and analysis created by one individual can be easily transferred to another. The primary purpose of this module 114 is to act as a form of transport for market analysis information. The marked analysis module 114 is intended to be accessed primarily by market analysts, who are individuals responsible for studying and interpreting market data to make informed decisions. However, it's emphasized that anyone can use this module 114, including the user themselves, fellow users, or even hypothetical individuals like “Joe Baiden.” The marked analysis module 114 operates within a larger context of a digital platform or application that likely provides tools for technical analysis of financial markets. The process of using the market analysis module 114 involves creating graphical elements on a digital chart, referred to as “drawings”. These drawings may include, but not limited to, lines, circles, and text annotations that help illustrate and explain market trends, patterns, and predictions. Additionally, indicators like moving averages can be enabled, adding another layer of analysis to the chart.

The sharing of these drawings and analysis content can occur through various modes. The various modes may include, but not limited to, email, In-App Message, Link, other methods, and the like. The user can send an email containing a link to the specific chart with their drawings and analysis. Further, In-App Message: Users can exchange messages within the application, including sharing links to their charts. Link: The user can generate a shareable link that leads directly to the chart with all the drawings and analysis. Finally, there could be other methods of sharing as well, potentially through social media, messaging apps, or other online platforms. Due to presence of market analysis module 114, the user is empowered to encompass the complete analysis content and visual elements, which encompasses drawings and indicators. The market analysis module 114 makes it easy for one user to replicate another user's analysis on their own chart with a single click of a button or by following a shared link. The market analysis module 114 streamlines the process of knowledge transfer between market analysts and other users.

The market analysis module 114 is designed to facilitate the sharing of personalized chart analysis and annotations between the first and second users. It serves as the bridge between the users' interactions and the chart output. This market analysis module 114 is configured to allow the first user to create and annotate charts based on their analysis of financial data. These annotations may include, but not limited, technical indicators, trend lines, support and resistance levels, and any other visual elements that aid in understanding the market trends. The unique feature of this market analysis module 114 is its ability to share these personalized chart analyses and annotations with a second user using various modes. This could involve sending the analysis as a separate file, as a link, or through direct integration with the second user's financial chart interface. Importantly, the market analysis module 114 makes it incredibly convenient for the second user to access the shared content by enabling them to view it with a simple click on their financial chart interface.

The market analyst provides trading insights related to trading and market for analyzing the market conditions, trends, and factors that impact a particular industry, product, or market segment on the basis of set of input details provided by the user into the market analysis module 114 and the insights are also transmitted to the email address and/or contact number of the user. Further, the trading insights include drawing explanation, lines, circle, comments, arrows and other similar graphical representations that aid in illustrating and communicating market or trading insights.

The market analyst provides the trade insights by identifying the objective which include trends, determine market strength or weakness, potential entry or exit points, or measure price volatility. Further, depending on the objective, the market analyst selects a suitable calculation method. The calculation method known in the art includes trend-following indicators, oscillators, volume-based indicators, and volatility indicators. Each type uses different calculations and formulas to derive insights from the price data. The indicators may include customizable parameters that influence the sensitivity and responsiveness to market conditions.

The market analysts determine the appropriate parameters based on historical analysis, market characteristics, and personal preferences. The parameters include lookback periods, smoothing factors, and standard deviation settings. The market analyst applies the indicator to the price data, which involves performing the necessary calculations on the historical price series to generate the indicator values. The calculations may involve mathematical formulas, moving averages, statistical calculations, or complex algorithms, depending on the indicator type. Once the indicator values are calculated, the market analyst interprets the results to derive meaningful insights, which involves studying the indicator's behavior in relation to the price chart, identifying patterns, crossovers, divergences, or other signals that may indicate potential trading opportunities or market conditions.

Further, within the market analysis module 114, the market analyst utilizes the set of input details provided by the user and the trading information available on the internet. The set of input details, such as the name, email address, and contact number, serve as the basis for gathering trading insights.

Furthermore, the market analyst transmits the generated trading insights to the user's provided email address and/or contact number which enables the user to conveniently receive and access the market analysis data, keeping informed about market conditions, trends, and factors that impact the chosen industry, product, or market segment.

Moreover, the trading insights provided by the market analyst within the market analysis module 114 includes various graphical representations, such as drawing explanations, lines, circles, comments, arrows, and similar elements. The graphical representations serve as visual aids in illustrating and effectively communicating market or trading insights to the user and further enhance the understanding of complex market concepts and facilitate the user's decision-making process.

The output module 116 is responsible for replicating and presenting the personalized chart analysis and annotations created by the first user onto the financial chart interface of the second user. It captures the visual elements, annotations, and indicators drawn by the first user and recreates them in the context of the second user's financial data. The output module's 116 key functionality lies in its ability to substitute the original financial chart interface of the second user with the content extracted from the first user's chart analysis. In other words, it superimposes the drawn content, annotations, and activated indicators from the first user's analysis onto the live financial chart interface of the second user. This enables the second user to directly visualize and compare their chart with the personalized analysis of the first user, enhancing their understanding of the market trends.

The system effectively facilitates the exchange of market-related information between the market analyst and the user. Through the output module 116 and the dashboard, the user interacts with and explore the market analysis data provided and an exchange of trading insights plays a crucial role in supporting the user in gaining valuable insights into market conditions and trends, empowering them to make informed trading decisions. The output module 116 used herein refers to display screens, mobile phone and tablets.

The dashboard used herein refers to a graphical user interface element or a display area in the output module 116. The dashboard serves as a consolidated view that presents relevant information, including the market analysis data, to the user in an organized and visually appealing manner. The dashboard depicted trading charts and trading graphs. The output module 116 includes price in euros or dollars. The input module 112 and the output module 116 further includes euros symbol, US dollars symbol, Japan yen symbol, British pound sterling symbol, Australian dollar symbol, Shiba Inu coin, New Zealand Dollar, and the like. The system 100 may include track option, user option, and home option, and the like. The track option involves keeping tabs on progress, updates, or specific items of interest. The user includes user profiles, account information, authentication, or user-specific preferences and permissions. The home option likely takes users back to the system's main or starting page.

The dashboard provides users with an at-a-glance overview of the key metrics, data, and insights related to their trading activities. Further, a specific content and layout of the dashboard may vary depending on the design and functionality of the system and includes charts, graphs, tables, and other visual representations that summarize and present the market analysis data in a clear and understandable format. The dashboard may also incorporate interactive features, allowing users to customize the displayed information based on the preferences or specific trading requirements.

The system further includes a content creation module 118 in which registers the user as analysts and allows the user to create a trade related content, share the content and at least one insight which includes drawings, analysis, and strategies for fostering a collaboration and a knowledge exchange among a user community.

Further, the content creation module 118 works on a set of pre-defined set of instructions for registration of user as analysts, for example, the set of instructions may include experience level more than 10 years or age more than 30 years. The content creation module 118 helps the user to express ideas, opinions and expertise related to trading and marketing by producing written articles, record videos, or utilize interactive media to convey the trade or market related insights effectively. Additionally, the user registered as analyst receive feedback, engage in discussions, and benefit from the diverse perspectives of the user community.

The system further comprises of a data transfer module 120 that is configured to transfer the insights along with the trading charts and trading graphs that are universally licensed into an external trading platform. The external platform includes popular trading software, online brokerage platforms, or any other trading-related applications, universally licensed into an external trading platform.

Additionally, the data transfer module 120 provides two transfer options wherein the two options include a code copying option and a data copying option. The code copying option corresponds to transmitting the trading insights along with an additional data including real time news signals along with accompanying charts for providing a set of detailed insights and visual representations to the user. The data copying option corresponds to transmitting the trading insights along with the additional data directly to the external trading platform for facilitating quick and informed decision making.

Further, if the user opts for code copying option, then a set of detailed insights and visual representations are provided to the user to gain a deep understanding of the analysed trading data. The code copying option assists the user to utilize the insights and accompanying charts to make informed decisions regarding trading strategies. The real-time news signals provide valuable information that help user stay updated with the latest market trends and events, facilitating timely and well-informed decision making. In conclusion, through the code copying option, the external trading platform may integrate the system with real time trading data.

Furthermore, if the user opts for data copying option, the user is able to seamlessly integrate the trading insights and additional data into the external trading platform workflow. The data copying option eliminates the need for manual data entry or importing, saving users valuable time and effort. The user quickly analyses the insights, leverage the accompanying data, and make well-informed trading decisions directly within the external trading platform.

Additionally, the system 200 for comprehensive trading analysis offers users a user-friendly interface to perform a comprehensive chart analysis in which the user is permitted to create drawings, annotations, and indicators directly on trading charts and also provides an interactive chart drawing functionality which allows users to mark key support and resistance levels, identify patterns, and highlight significant data points. According to an exemplary embodiment, the system 200 for comprehensive trading analysis provides a wide range of intuitive tools and customization options to suit individual trading preferences.

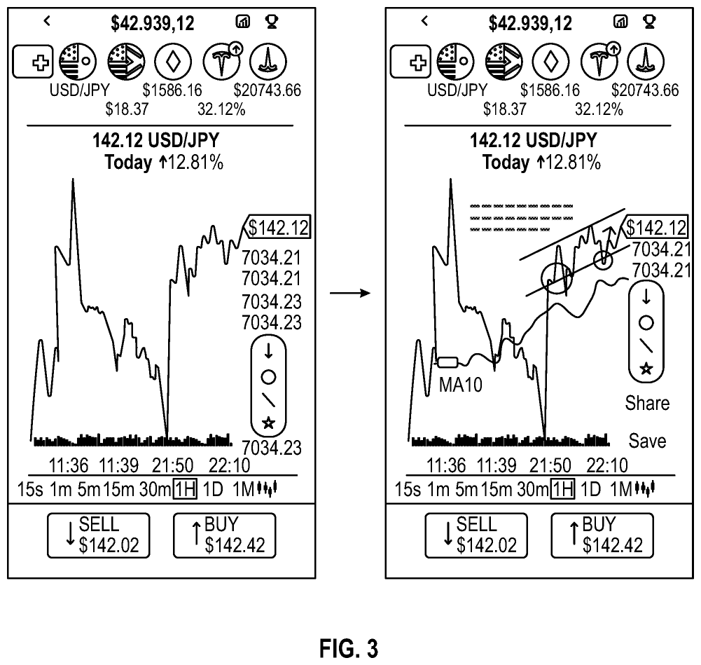

In addition to that, the system 200 for comprehensive trading analysis offers seamless embedding of trading charts on web pages. The users effortlessly integrate a set of annotated charts into websites, blogs, or other online platforms, enhancing the visibility and accessibility of the trading analysis, which is particularly useful for financial bloggers, analysts, or educators who want to present the insights in a visually engaging manner. In addition to embedding, the system 200 facilitates easy sharing of trading charts. The users are permitted to save the set of annotated charts in the personal feeds within the system 200 and share with others as links or messages and the sharing capability in the system 200 fosters collaboration, allowing traders to exchange ideas, discuss strategies, and provide feedback on specific trading scenarios as depicted in FIG. 3. By allowing users to store their personalized chart analyses within their personal feeds, the system 200 offers a cohesive and organized way to keep track of their trading strategies, observations, and market trends over time. This archived collection becomes a valuable resource for users to revisit their past analyses, learn from historical patterns, and refine their trading strategies based on previous experiences. Users can share their analyses with others through direct links or messages. Sharing links enables easy access for recipients to view the charts without any complex setup, ensuring a streamlined experience. Additionally, sharing through messages facilitates one-on-one communication, where traders can target specific individuals for collaboration, advice, or feedback.

Furthermore, the system 200 includes a feature in which the first user is permitted to copy trading insights that is universally licensed and apply to other real trading platforms, for revolutionizing the way traders analyse and execute the strategies as depicted in FIG. 3. Further, the user is provided with two options for integration of the feature to the other real trading platforms and the two options include a code copying option and a data copying option. Furthermore, if the user opts for the code copying option, then the system enables the user to receive the insights which also include real time news signals along with accompanying charts for providing a set of detailed insights and visual representations to the user.

Additionally, if the user opts for data copying option, the user is permitted to copy the trading insights directly to a plurality of trading charts present in the other real trading platforms for facilitating quick and informed decision making. For instance, if renowned platforms express interest in integrating the feature, the system provides two options either embed a provided code, enabling to receive the news signals along with accompanying charts, or adopt a concept within the existing infrastructure. In the latter scenario, the analysts are allowed to disseminate emails and news updates while allowing the users to copy the trading insights directly to the chart.

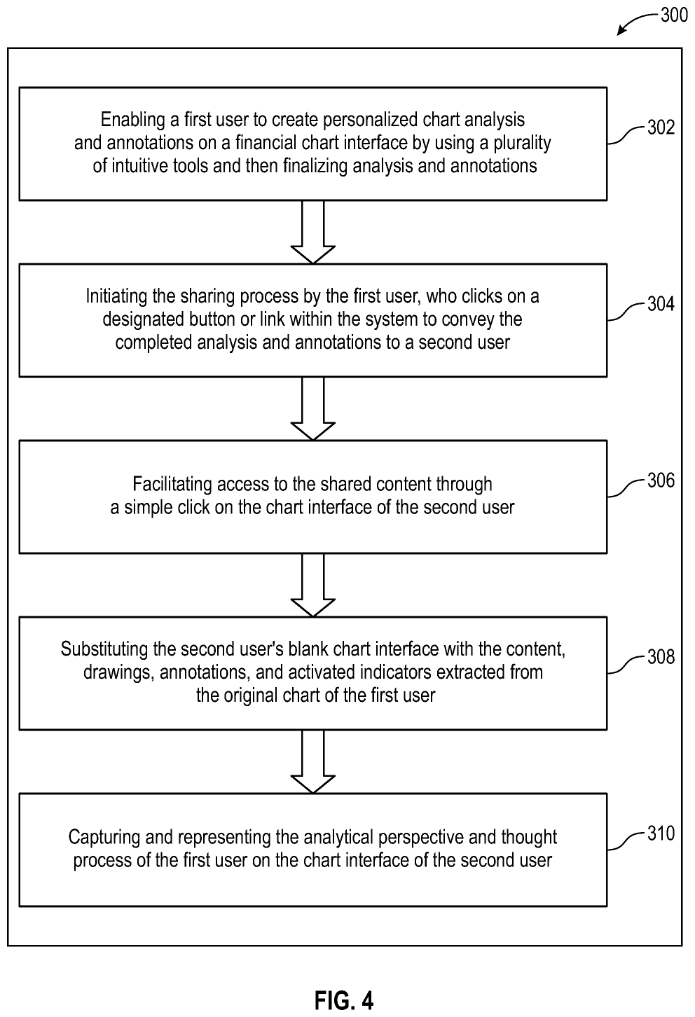

FIG. 4 is a flow diagram illustrating an exemplary method for efficient sharing and replication of trading analysis is disclosed, in accordance with embodiment of the present invention. The method 300, comprising step 302 enabling a first user to create personalized chart analysis and annotations on a financial chart interface by using a plurality of intuitive tools and then finalizing analysis and annotations. Further the method 300 comprising step 304 of initiating the sharing process by the first user, who clicks on a designated button or link within the system to convey the completed analysis and annotations to a second user and further the method comprising in step 306 facilitating access to the shared content through a simple click on the chart interface of the second user. Further the method 300 comprising step 308 of substituting the second user's financial chart interface with the content, drawings, annotations, and activated indicators extracted from the original chart of the first user. Further the method 300 comprising step 310 of capturing and replicating the analytical perspective and thought process of the first user on the chart interface of the second user.

At step 302, the method 300 includes the input module configured to receive a set of input details and contact details from a first user, the input module is configured to enable the first user to create personalized chart analysis and annotations on a financial chart interface by using intuitive tools, the intuitive tools configured to allow the first user to draw lines, circles, add text comments, and integrate indicators on the financial chart interface.

At step 304, the method 300 includes a market analysis module which is accessed by a first user within the system. In continuation, the market analyst provides trading insights for analysis within the market analysis module. The market analysis module is configured to enable the first user to share the personalized chart analysis and annotations with a second user through various modes. The various modes may include, but not limited to, email, In-App Message, Link, button, and other methods. At least one trading insight serves the purpose of examining market conditions, trends, and factors that affect a particular industry, product, or market segment. The provided at least one trading insight includes various graphical elements such as drawing explanations, lines, circles, comments, arrows, and similar visual aids that aid in illustrating and communicating market insights effectively.

Additionally, at step 306, the method 300 includes, when the second user receives a link or notification about shared content, they can effortlessly access it by clicking on the chart interface. This seamless integration eliminates the need for complex procedures, additional downloads, or navigating through multiple menus. It ensures that the shared analysis becomes an integral part of the user's existing charting environment without disrupting their workflow.

Additionally, at steps 308 and 310, the method 300 includes, dynamically replacing the second user's standard chart display with the personalized insights and visual elements from the first user's chart. For example, by substituting the second user's chart with the content from the first user, traders can perform detailed comparative analysis. The second users can simultaneously view their own analysis and annotations alongside those of the first user. This side-by-side comparison offers a unique perspective on market trends, insights, and strategies. Traders can identify differences in interpretations, observe overlapping indicators, and refine their strategies based on shared insights.

The method includes, the captured data and analysis are then replicated on the financial chart interface of the second user. This involves re-creating the steps taken by the first user in their analytical process. This could include drawing trendlines, placing indicators, marking support and resistance levels, and any other actions that contributed to their analysis. As the analytical perspective is replicated, the second user has the option to play back the entire analytical process step by step. This visual playback allows them to see the progression of the analysis, how it evolved, and the key moments that influenced decision points.

Overall, the method 300 involves receiving details, accessing a market analysis module by a market analyst, providing market-related data for analysis, and enabling users to copy the at least one trading insight to a dashboard within the system. The method facilitates the exchange of valuable market information, empowering users to gain insights into market conditions, trends, and factors that impact their chosen industry, product, or market segment.

The method 300 may be implemented in any suitable hardware, software, firmware, or combination thereof.

The system and method for efficient sharing and replication of trading analysis offer several key features to enhance the user's learning experience. The user utilize the system and method to learn how to invest effectively, sharpen their knowledge through challenging quizzes, and develop the skills.

The system also provides a practical trading environment by offering a diverse range of financial instruments, including but not limited to 50 most in-demand stocks, 26 currencies, 5 indexes, 14 cryptocurrencies, and 10 highly traded commodities. This comprehensive range of options enables users to practice trading across different markets and asset classes, gaining valuable hands-on experience and refining their trading strategies. Furthermore, the user receives the message or email with the market analyst's data and the user is permitted to copy to a chart presented over the dashboard for a better understanding.

Thus, various embodiments of the present invention provide system and method for efficient sharing and replication of trading analysis which ensures that users have a seamless and integrated experience throughout the trading journey. The system and method for efficient sharing and replication of trading analysis allows for a personalized user experience by collecting specific input details, such as name, email address, and personal preferences related to trading and the set of input details is used to create a user account and tailor the experience accordingly. Additionally, the market analysis module is accessible to market analysts who provide valuable data and insights into market conditions, trends, and factors impacting specific industries or market segments. Further the users are allowed copy this data to a dashboard displayed in the output module, which serves as a consolidated view for easy access and review of market analysis information. Overall, the system and method offer convenience, personalization, and valuable insights, enabling users to make informed trading decisions. The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by at least one other devices which is not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

We claim:

1. A system for efficient sharing and replication of trading analysis, the system comprising:
a) at least one hardware processor; and
b) a memory coupled to the at least one hardware processor, wherein the memory comprises a plurality of modules in the form of programmable instructions executable by the at least one hardware processor, and wherein the plurality of modules comprises:
i) an input module configured to receive a set of input details and contact details from a first user, the input module configured to enable the first user to create personalized chart analysis and annotations on a financial chart interface by using a plurality of intuitive tools, wherein the plurality of intuitive tools configured to allow the first user to draw lines, circles, add text comments, and integrate indicators on the financial chart interface;
ii) a market analysis module configured to enable the first user to share the personalized chart analysis and annotations with a second user through various modes, wherein the market analysis module configured to facilitate access to the chart analysis and annotations through a simple click on a financial chart interface of the second user; and
iii) an output module configured to capture and replicate the personalized chart analysis and annotations of the first user on the financial chart interface of the second user, wherein the market analysis module configured to substitute the second user's chart interface with content, drawings, annotations, and activated indicators extracted from the financial chart interface of the first user.

2. The system of claim 1, wherein the various modes comprise email, In-App Message, Link, button, and other methods.

3. The system of claim 1, wherein the set of input details comprises name, email address, password, phone number, date of birth, profile picture of the user and personal preferences related to trading, and wherein the set of contact details include at least one email address or contact number of the user.

4. The system of claim 1, wherein the personalized chart analysis and annotations comprise drawing explanation, lines, circle, comments, arrows, and other similar graphical representations that aid in illustrating and communicating market or trading insights.

5. The system of claim 1, wherein the market analysis module configured to enable a market analyst to provide at least one insight based on market conditions, trends, and factors that impact at least one of a particular industry, a product, and a market segment.

6. The system of claim 1, further comprising a content creation module configured to register the user as an analyst in the system and create a trade related content, wherein the user is allowed to share the content for fostering a collaboration and a knowledge exchange among a user community, wherein the user is provided with an option to calibrate the content over the dashboard for performing the comprehensive trading analysis.

7. The system of claim 1, wherein the output module configured to depict dashboard of at least one trading chart and at least one trading graph.

8. A method for efficient sharing and replication of trading analysis, the method comprising:
a) receiving, by at least one hardware processor, a set of input details and contact details;
b) enabling a first user to create personalized chart analysis and annotations on a financial chart interface by using a plurality of intuitive tools and then finalizing analysis and annotations, wherein the plurality of intuitive tools configured to allow the first user to draw lines, circles, add text comments, and integrate indicators on the financial chart interface;
c) sharing the personalized chart analysis and annotations with a second user by the first user through various modes, wherein the market analysis module configured to facilitate access to the chart analysis and annotations through a simple click on a financial chart interface of the second user; and
d) capturing and replicating the personalized chart analysis and annotations of the first user on the financial chart interface of the second user, wherein the market analysis module configured to substitute the second user's chart interface with content, drawings, annotations, and activated indicators extracted from the financial chart interface of the first user.

9. The method of claim 8, wherein the set of input details include name, email address, password, phone number, date of birth, profile picture of the user and personal preferences related to trading, and wherein the set of contact details include at least one email address or contact number of the user.

10. The method of claim 8, wherein the the chart analysis and annotations include drawing explanation, lines, circle, comments, arrows, and other similar graphical representations that aid in illustrating and communicating market or trading insights.

11. The method of claim 8, further comprising a step of providing at least one insight by a market analyst based on market conditions, trends, and factors that impact at least one of a particular industry, a product, and a market segment.

12. The method of claim 8, further comprising a step of registering the user as an analyst and creating a content, wherein the user is allowed to share the content for fostering a collaboration and a knowledge exchange among a user community, wherein the user is provided with an option to calibrate the content over the dashboard for performing the comprehensive trading analysis.

13. The method of claim 8, wherein the dashboard depicted at least one trading chart and at least one trading graph.

14. The method of claim 8, further comprising a step of transferring of the at least one insight along with the at least one trading chart and at least one trading graph that are universally licensed into an external trading platform.

15. The method of claim 14, further comprising a step of transferring of the at least one insight along with the at least one trading chart and at least one trading graph to external trading platform is done by two options, and wherein the two options include a code copying option and a data copying option.

16. The method of claim 15, wherein the code copying option corresponds to transmitting the at least one trading insight along with an additional data including real time news signals along with accompanying charts for providing a set of detailed insights and visual representations.

17. The method of claim 16, wherein the data copying option corresponds to transmitting the at least one trading insight along with the additional data directly to the external trading platform for facilitating quick and informed decision making.
